(19) United States
(12) Patent Application Publication
(10) Pub. No.: US 2016/0184621 A1
(43) Pub. Date: Jun. 30, 2016

(54) Drug Disposal System

(71) Applicant: Board of Regents, The University of Texas System, Austin, TX (US)

(72) Inventors: Kevin Albert Schug, Southlake, TX (US); Nour Moussa Hussein, Maumelle, AR (US); Shadi Rajai Zumut, Keller, TX (US)

(73) Assignee: Board of Regents, The University of Texas System, Austin, TX (US)

(21) Appl. No.: 15/058,321

(22) Filed: Mar. 2, 2016

Related U.S. Application Data
(63) Continuation-in-part of application No. 14/889,628, filed on Nov. 6, 2015.
(60) Provisional application No. 61/820,255, filed on May 7, 2013.

(51) Int. Cl. A62D 3/33

(52) U.S. Cl. CPC A62D 3/33; A62D 2101/26

(57) ABSTRACT

A safe and effective system for removal of a range of common pharmaceutical compounds. The formulation comprises activated carbon, accompanied by a dissolution aid, such as a larger pebble-like material, in the presence of an acidified liquid medium. In one exemplary method, drugs are added to the formulation in a container, whereby chemicals contained within the drug are irreversibly adsorbed onto activated carbon, thereby rendering them inactive and sequestered from further use.

### CROSS-REFERENCE TO RELATED APPLICATIONS

This application is a continuation-in-part of U.S. patent application Ser. No. 14/889,628, filed Nov. 6, 2015, which is a U.S. National Stage of International Patent Application Ser. No. PCT/US2014/037096, filed May 7, 2014 entitled “Drug Disposal System” by Kevin Albert Schug, Nour Moussa Hussein, and Shadi Rajai Zumut, which claims priority to U.S. Provisional Patent Application Ser. No. 61/820,255. The disclosure of the above-identified co-pending application is incorporated herein by reference in its entirety.

### BACKGROUND

The technology relates to disposal of chemicals. More specifically the technology relates to safe and effective systems for home, office, hospital, clinic, or governmental disposal of drugs, such as prescription drugs.

The proper disposal of expired and otherwise unused drug compounds is an important issue for both personal health and environmental reasons. There is a clear need for reliable systems which can be used by individual consumers, pharmacies, other health care providers, and governments in order to insure that unused pharmaceuticals are not available for consumption, either abusive or otherwise, or released into the environment due to improper disposal.

### SUMMARY OF THE TECHNOLOGY

The present technology comprises safe and effective systems for sequestration and disposal of a range of common pharmaceutical compounds. These compounds possess a range of physicochemical properties (size, solubility, chemical functional units, etc.), and are found in both prescribed and over-the-counter medications.

In one aspect, the technology is a system for drug disposal that includes activated carbon in the presence of an aqueous acid and a mechanical dissolution aid, such as a pebble-like material to help break up capsules and tablets and aid dissolution of pharmaceutical compounds upon shaking. In various embodiments, the system is preferably in the form of slurry in a container, such as a bottle.

In an exemplary method of the instant drug disposal technology, drugs are added to a slurry of activated carbon, aqueous acid, and a mechanical dissolution aid in a container, whereby the chemicals contained in the drug are irreversibly adsorbed onto the activated carbon, thereby rendering said chemicals inactive and sequestered from further use.

According to various embodiments of the technology, a kit for drug disposal includes activated carbon, a mechanical dissolution aid, a container, and instructions for activating the kit for disposal of a drug product. In a further embodiment, the instructions specify an amount of aqueous acid to add to the kit in order to inactivate and sequester the active ingredients contained in the drug product.

A variety of drug compounds, representing a range of formulations and chemical structures can be effectively inactivated using the system.

### BRIEF DESCRIPTION OF THE DRAWING

FIG. 1 is a drawing of an embodiment of the technology.

FIG. 2 shows a method for disposal of drugs according to one embodiment of the technology.

FIG. 3 shows loading capacity comparison results between acid A (AA) and acid B (AB).

### DETAILED DESCRIPTION OF THE TECHNOLOGY

In one embodiment, the system includes a slurry of an aqueous acid, activated carbon, and a mechanical dissolution aid in a container. A drug to be disposed is added to the slurry in the container and shaken or agitated, whereupon the chemicals within the drug are irreversibly adsorbed by the activated carbon, and the container can then be disposed.

In various embodiments, the aqueous acid is formic acid and/or acetic acid. Some embodiments include an acid that is not acetic acid or formic acid. In one exemplary embodiment, a co-solvent such as methanol is also added to the slurry.

Activated carbon is included in the slurry in an amount of about 50 g per 100 ml of aqueous acid. The activated carbon can have a variety of mesh sizes and can be powdered activated carbon (PAC) or granulated activated carbon (GAC). It can have a surface area ranging from about 500 m²/g and up to about 1750 m²/g. Examples of activated carbon include GAC 8/20, GAC 12/40, GAC 8/30, K-BG, S-51, Norit SX-4 (PAC), and Norit SX-Ultra (PAC).

The mechanical dissolution aid can be a plurality of pebbles. The pebbles are desirably approximately 0.2-0.7 cm in diameter for small containers, such as less than 1 gallon. Larger size pebbles such as 1-2 cm are desirable in some cases, particularly for 1 gallon, 5 gallon or larger containers. The pebbles may be any shape including irregular shape, spherical or cubic. The amount of pebbles added to the formula can range from one to four times the amount (by weight) of the activated carbon used. The mechanical dissolution aid prevents clumping of the activated carbon in the sample slurry; it also increases dispersion of the activated carbon in the solution upon shaking.

The solution, activated carbon, and mechanical dissolution aids are placed in a container such as a plastic bottle. Any size bottle can be used. A convenient option is an 8 oz. plastic bottle, which desirably will contain about 4-6 oz. solution, 20 to 50 g of activated carbon, and 40 to 150 g of pebbles. Much larger containers, such as 55 gallon barrels are also appropriate, with appropriate means added for shaking and/or mixing, which could include any suitable drum mixing methods known in the art of large volume mixing.

In another embodiment the container is a one gallon container containing similar ingredients in similar proportions. Other containers can be used so long as they do not interfere with the ingredients and can preferably be disposed of after use. The bottle is provided to the end user as a kit including at least the activated carbon, and mechanical dissolution aid therein.

The kit includes instructions for activating the kit for drug disposal. It is particularly desirable that the labeling and/or instructions provided with the disposal system specify a given amount of active ingredient that the product can reliably sequester before the activated charcoal is overloaded. Activating the kit for drug disposal includes steps to be taken to inactivate and sequester the ingredients in the drug product. The kit may be supplied with an aqueous acid, either separately, or contained within the disposal container. In various embodiments, the kit instructions specify an amount of aqueous acid to add to the kit components so as to inactivate and sequester the ingredients contained within the drug product. Inactivated ingredients include those within the drug product that are no longer available for use because they are adsorbed by activated carbon. Adsorbing onto activated carbon precludes use by a consumer of the drug. The drug may or may not be transformed into another chemical compound when it is adsorbed onto the activated carbon. Under conditions necessary for release of the drug from the activated carbon, such as very high temperatures or under conditions of excessive acidity or alkalinity, the drug would most likely be transformed and degraded.

In a typical case, the chemical ingredients to be inactivated and sequestered are the active ingredients in the drug product, but in other situations, it may be desirable to inactivate other ingredients in the drug product. Such other “inactive” ingredients, may include, for example, polymer excipients and buffers. After use, the bottle can desirably be securely sealed and disposed. Preferably the bottle is sealed with a childproof top, or another type of seal that cannot be easily reopened.

The bottle is desirably supplied to the end user having an amount of the formulation inside. Preferably the bottle is about 50% filled with the formulation but it can be more or less filled, generally between about 50% and 90%. The user obtains a system having the capacity needed to dispose a certain amount of drug ingredient. Desirably, systems are provided having a capacity of from about 2.25 g (in an 8 oz. bottle) to about 3 kg (in a 55 gal. drum) of active drug ingredient (not including inactive ingredients). The bottle drug capacity was determined as a conservative estimate based on trials where increasing doses of acetaminophen were added to a given amount of activated carbon, in order to determine the threshold of non-sequestration. The threshold is likely realistically about 1.5 to 2 times this value. In a related embodiment for solid drug disposal, the capacity of the activated carbon in a related but different format was demonstrated for a wide range of drugs with variable physicochemical character.

The drug or drugs are added to the bottle, which is then shaken or agitated for a period of time, such as two minutes, and allowed to stand for another period of time, such as for about one hour. The chemicals contained within the drug product are irreversibly adsorbed onto the activated carbon, thus rendering them sequestered and inactive. In various embodiments, instructions provided with the drug disposal system specify the times for agitating and standing in order to inactivate a particular drug.

Any type of drug product can be disposed of using the system as long as the mass of the active ingredient specified for the given bottle size is not significantly exceeded. According to various embodiments, the drug is a solution based drug product, such as an oral solution, an injectable drug, a cream, or a gel. The solution based drug may include one or more active ingredients, such as acetaminophen, diazepam, hydrocodone, oxycodone, morphine, and phenobarbital. Exemplary prescription solution based drugs that may be disposed are listed in Table 1. Representative experimental drug mixtures added to a slurry according to the drug disposal technology are shown in Table 2.

TABLE 1
Prescription Liquid Drug Compositions

| | | Drug (mg) | | Total | Alcohol | Drug (mg/mL) | |
|---|---|---|---|---|---|---|---|
| Trade Mark | Prescription Name | A | B | Vol. (mL) | (%) | A | B |
| Zamicet | Hydrocodone Bitartrate and | 10 | 325 | 15 | 6.7 | 0.67 | 21.67 |
| | Acetaminophen oral solution | | | | | | |
| Zolvit | Hydrocodone Bitartrate and | 10 | 300 | 15 | 7 | 0.67 | 20.00 |
| | Acetaminophen oral solution | | | | | | |
| Qualitest | Hydrocodone Bitartrate and | 7.5 | 500 | 15 | 7 | 0.50 | 33.33 |
| | Acetaminophen oral solution | | | | | | |
| Boca | Hydrocodone Bitartrate and | 7.5 | 325 | 15 | 7 | 0.50 | 21.67 |
| Pharmacal | Acetaminophen oral solution | | | | | | |
| Mallinckrodt | Oxycodone | 5 | 325 | 5 | | 1 | 65.00 |
| | Hydrochloride/Acetaminophen Oral | | | | | | |
| | Solution | | | | | | |
| Lannet | Oxycodone Hydrochloride Concentrate | 20 | | 1 | | 20 | |
| | Solution | | | | | | |
| Roxicodone | Oxycodone Hydrochloride | 5 | | 5 | | 1 | |
| MGP | Acetaminophen/Codeine Phosphate | 120 | 12 | 5 | 7.3 | 24 | 2.4 |
| Qualitest | Acetaminophen/Codeine Phosphate | 120 | 12 | 5 | 6.65 | 24 | 2.4 |
| Qualitest | Phenobarbital Elixir | 20 | | 5 | 15 | 4 | |
| Alpharma | Phenobarbital Elixir | 20 | | 5 | 13.5 | 4 | |
| | Phenobarbital Sodium Injection | 65 | | 1 | | 65 | |
| | Phenobarbital Sodium Injection | 130 | | 1 | | 130 | |
| Physician | Belladonna/Phenobarbital: | 16.2 | 0.1037/ | 5 | 23.8 | 3.24 | |
| Partner Rx | Phenobarbital/Hyoscyamine/Atropine/ | | 0.0194/ | | | | |
| | Scopolamine | | 0.0065 | | | | |
| Roxane Labs | Diazepam Oral Solution | 5 | | 5 | | 1 | |
| | Diazepam Oral Solution | 5 | | 1 | | 5 | |
| TEVA | Diazepam Rectal Gel | 2.5 | | Syringe | | | |
| TEVA | Diazepam Rectal Gel | 10 | | Syringe | | | |
| Lannett | Morphine Sulfate Solution | 20 | | 1 | | 20 | |
| Roxane Labs | Morphine Sulfate Solution | 10 | | 5 | | 2 | |
| Roxane Labs | Morphine Sulfate Solution | 20 | | 5 | | 4 | |

TABLE 2
Liquid Drugs

| Slurry Composition | | | | |
|---|---|---|---|---|
| Formic | | | | |
| Acid In | Methanol | Customer | Sample | |
| Water (mL) | (%) | ID # | Drug A | Drug B |
| 50 | 10% | LDDA #1A | Diazepam | |
| 50 | 10% | LDDA #1B | Morphine | |
| 70 | 10% | LDDA #3A | Morphine | |
| 70 | 10% | LDDA #3B | Phenobarbital | |
| 50 | 15% | LDDA #5A | Morphine | |
| 50 | 15% | LDDA #5B | Phenobarbital | |
| 70 | 15% | LDDA #6A | Hydrocodone | Acetaminophen |
| 70 | 15% | LDDA #6B* | Hydrocodone | Acetaminophen |
| 50 | 10% | LDDA #1C* | Hydrocodone | Acetaminophen |
| 70 | 10% | LDDA #3C* | Hydrocodone | Acetaminophen |
| 50 | 15% | LDDA #5C | Hydrocodone | Acetaminophen |
| 70 | 15% | LDDA #6C | Hydrocodone | Acetaminophen |
| 50 | 10% | LDDA #1D | Oxycodone | Acetaminophen |
| 70 | 10% | LDDA #3D | Oxycodone | Acetaminophen |
| 50 | 15% | LDDA #5D* | Oxycodone | Acetaminophen |
| 70 | 15% | LDDA #6D | Oxycodone | Acetaminophen |

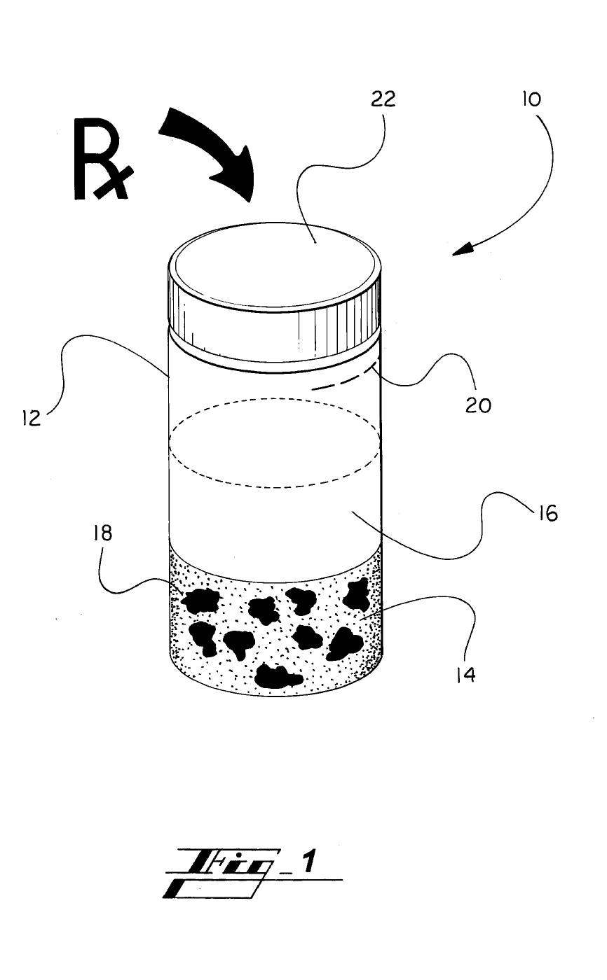

FIG. 1 illustrates an exemplary embodiment of the system 10. Bottle 12 contains fine-grade activated charcoal 14, an acidic solution 16, and pebbles 18. A fill line 20 is indicated on the bottle 12 and the bottle 12 is closed with a cap 22.

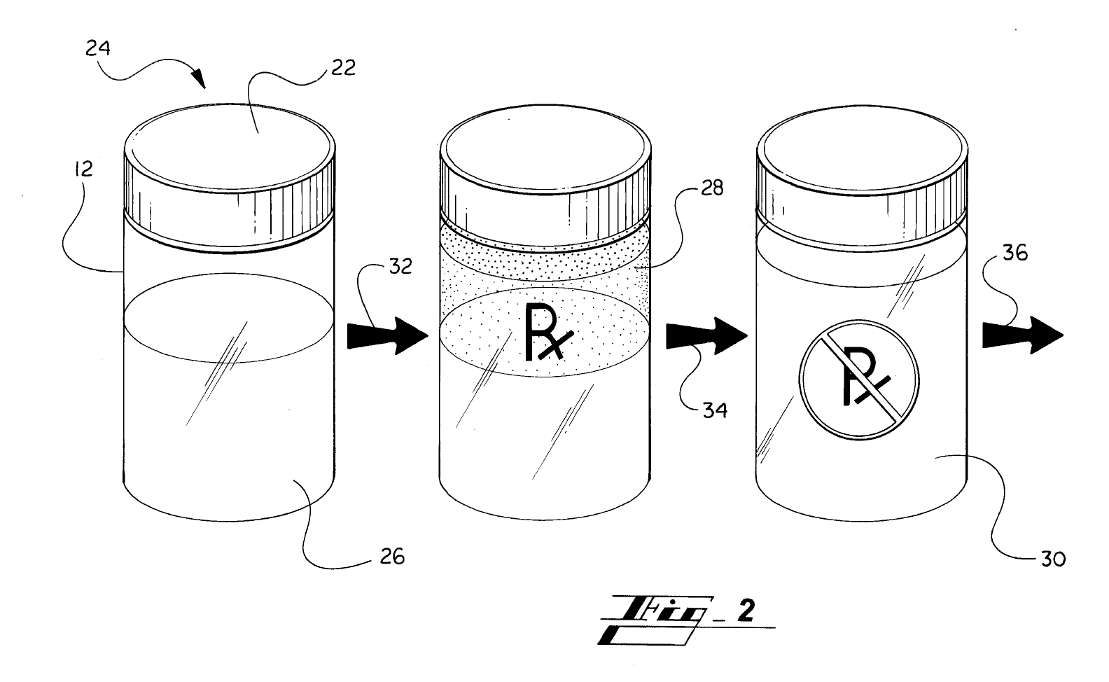

FIG. 2 illustrates a method of drug disposal using the system 24. Bottle 12 including a cap 22 contains a slurry, 26, of activated charcoal, aqueous acid, and a mechanical dissolution aid. In step 32, a solution based drug product 28 is added to the slurry 26 in the bottle. In a step 34, the container (bottle 12+cap 22) is shaken for a certain amount of time and let stand for a certain amount of time. Step 34 results in a product 30 where at least the active ingredient of the drug product 28 is sequestered and rendered inactive. In a step 36, the product 30 can then be safely disposed.

The examples below serve to further illustrate exemplary embodiments, to provide those of ordinary skill in the art with a complete disclosure and description of how the compounds, compositions, articles, devices, and/or methods claimed herein are made and evaluated, and are not intended to limit the scope of the disclosure. In the examples, unless expressly stated otherwise, amounts and percentages are by weight, temperature is in degrees Celsius or is at ambient temperature, and pressure is at or near atmospheric.

### Example 1

The effectiveness of the system for removal of a range of common pharmaceutical compounds was tested. The system included an 8 oz. plastic bottle, formic acid solution, activated carbon, and pebbles.

100 g of aquarium pebbles were added to the 8 oz. polypropylene bottle. Black pebbles brand Aqua Culture Aquarium Gravel were used.

125 mL of a formic acid/methanol solution was added to the bottle, prepared as follows. Formic acid (from JT Baker) can usually be purchased at a concentration of 85-88% in water and is diluted with water until it is 15% concentration (i.e., if the formic acid is 85%, then mix 3 parts of 85% formic acid with 17 parts water). The 15% formic acid was then mixed with methanol to create the formula solution (mix 4 parts of 15% formic acid with 1 part methanol). The methanol was ACS grade, purchased from Fisher Scientific.

37.5 g of powdered activated carbon was added to the bottle. The powdered activated carbon was Norit SX-4 (also called Norit SX-Ultra), purchased from Sigma-Aldrich.

The bottle was capped tightly and shaken well to mix. Following shaking, the bottle was let stand for 30 minutes capped loosely. Some outgassing may be observed.

The compounds tested, shown in Table 3, possess a range of physicochemical properties (size, solubility, chemical functional units, etc.) and are found in both prescribed and over-the-counter medications. As can be seen in Table 3, a combination of 45 pills of 8 different types, which contain different levels of active ingredients, was chosen to approach the limit of active ingredients indicated on the bottle (2250 mg active ingredient in the 8 oz. bottle).

Three separate trials were performed. In each trial, the mixture of pills was introduced into the bottle, shaken well by hand for approximately two minutes, and then allowed to sit for an hour. A sample was taken at one hour and analyzed by high performance liquid chromatography-mass spectrometry (HPLC-MS). The peak area for each drug compound of interest was monitored and compared to that obtained from an equivalent aliquot of drug compound dissolved directly in solution. The analysis was performed on a Shimadzu LCMS-2020 single quadrupole electrospray ionization-mass spectrometry, operated in the positive ionization mode. A standard mobile phase gradient on a C18 column (Phenomenex) was used to perform the liquid chromatographic separation in the reversed phase. Appropriate dilutions of the standard solutions and the product solutions were made to ensure that all monitored signals were on scale.

TABLE 3

| | | | Total | | |
|---|---|---|---|---|---|
| | | | Active | Total | Active |
| | Active | Number | Ingredient | Mass of | Ingredient |
| | Ingredient | Pills Per | Per Trial | Pills Per | Removed |
| Medication | (mg/pill) | Trial | (mg) | Trial (mg) | After 1 Hour |
| Buspirone | 30 | 6 | 180 | 2416 | 98.9% |
| Diphen- | 25 | 5 | 125 | 1252 | 97.3% |
| hydramine | | | | | |
| Duloxetine | 30 | 8 | 240 | 1700 | >99.9% |
| Fluoxetine | 10 | 6 | 60 | 1640 | 99.5% |
| Metoprolol | 50 | 3 | 150 | 647 | 97.0% |
| tartrate | | | | | |
| Paracetamol | 500 | 1 | 500 | 598 | 99.0% |
| Simvastatin | 20 | 12 | 240 | 2450 | >99.9% |
| Valsartan | 80 | 4 | 320 | 641 | >99.9% |
| TOTAL or | 93 | 45 | 1815 | 11344 | 99.0% |
| AVERAGE | (average) | (total) | (total) | (total) | (average) |

The product removed virtually all active ingredients from detection. The maximum active ingredient specified (2250 mg/8 oz. bottle) was not exceeded.

### Example 2

The same system as in Example 1 was used, with the exception that K-BG activated charcoal was used. Various amounts of acetaminophen were used to test the system. The results are shown in Table 4.

TABLE 4
K-BG* Charcoal, Surface Area = 1700 m²/g

| ACETO (mg) | Intensity of K-BG | Free Aceto | Adsorbed | Adsorbed |
|---|---|---|---|---|
| in 125 mL | (1 uL-Injection) | (mg) | (mg) | (%) |
| 2000 | 253444 | 36.66 | 1963.34 | 98.17 |
| 2500 | 672459 | 60.34 | 2439.66 | 97.59 |
| 3000 | 1157411 | 87.74 | 2912.26 | 97.08 |
| 3500 | 1660554 | 116.17 | 3383.83 | 96.68 |
| 4000 | 2372938 | 156.42 | 3843.58 | 96.09 |
| 4500 | 2842043 | 182.93 | 4317.07 | 95.93 |

*For the 2000 mg sample, only 35 g out of the 37.5 g of K-BG Charcoal was added.

### Example 3

The same system as in Example 1 was used, with the exception that S-51 activated charcoal was used. Various amounts of acetaminophen were used to test the system. The results are shown in Table 5.

TABLE 5
S-51 Charcoal, Surfaced Area = 650 m²/g

| ACETO (mg) | Intensity of S-51 | Free | Adsorbed | Adsorbed |
|---|---|---|---|---|
| in 125 mL | (1 uL-Injection) | Aceto (mg) | (mg) | (%) |
| 2000 | 109408 | 28.53 | 1971.47 | 98.57 |
| 2500 | 410492 | 45.54 | 2454.46 | 98.18 |
| 3000 | 1168471 | 88.37 | 2911.63 | 97.05 |
| 3500 | 1770414 | 122.38 | 3377.62 | 96.50 |
| 4000 | 2856454 | 183.74 | 3816.26 | 95.41 |
| 4500 | 7503896 | 446.34 | 4053.66 | 90.08 |

### Example 4

An experiment was performed to determine the break-through amount of adsorption capacity for a gallon-size system. The components of the system of example 1 were used in the following amounts with a 1 gallon plastic container: activated carbon 450 g, aquarium rocks 1000 g, formic acid (85%) 165 ml, water 960 ml, methanol 225 ml. Acetaminophen was used to test the absorption capacity of the system.

Acetaminophen tablets were added to reach the indicated amounts of active ingredient shown in Table 4. The bottle was then shaken and let sit for an hour (on average), and then the solution was sampled, filtered, and analyzed for the presence of acetaminophen by liquid chromatography-mass spectrometry.

What became apparent is that proportionally, the gallon formula could hold a lot more than anticipated.

As shown in Table 6, 185 grams worth of acetaminophen was applied to the system with no breakthrough. Greater than 99.99% of it was adsorbed. Extrapolated results indicate that breakthrough appears to be somewhere closer to 626 grams of acetaminophen (preliminarily 90% adsorbed). This is over 1000 acetaminophen pills.

TABLE 6

| | | Intensity | | | |
|---|---|---|---|---|---|
| Aceta | Aceta (mg) | of | Free | | |
| (mg) | 1:100 10 uL- | (10 uL- | Aceto | Adsorbed | Adsorbed |
| added | Injection | Injection) | (mg) | (mg) | (%) |
| 135000 | 7.50E−03 | 1174072 | 3.69E−03 | 134999.996 | 100.00 |
| 145000 | 8.06E−03 | 1480035 | 4.58E−03 | 144999.995 | 100.00 |
| 155000 | 8.61E−03 | 1480615 | 4.58E−03 | 154999.995 | 100.00 |
| 165000 | 9.17E−03 | 1506134 | 4.66E−03 | 164999.995 | 100.00 |
| 175000 | 9.72E−03 | 1353817 | 4.21E−03 | 174999.996 | 100.00 |
| 185000 | 1.03E−02 | 1568295 | 4.84E−03 | 184999.995 | 100.00 |

### Example 5

### Liquid Samples

Acetaminophen was used to test the applicability of the system for liquid drugs because it is used in higher doses compared to other drugs such as codeine and hydrocodone, for example.

Empty 8-oz bottles were acquired from Dalden (Trophy Club, TX). A proprietary formulation was prepared at The University of Texas at Arlington (Arlington, Tex.), which had a composition similar to that used for solid drug disposal, with exception of the type of acids added. Two bottles were prepared with this liquid-drug formulation, each containing a different type of acid (acid A and acid B) in order to test the efficacy of these two acids individually.

A stock acetaminophen solution was made on-site to mimic the composition of common liquid commercial drug. This solution was used to load 8-oz acid A bottle and 8-oz acid B bottle.

### Slurry Preparation

8-oz bottles were prepared by adding 50 g of aquarium pebbles, 50 g of activated carbon (composed of 1:1 mixture of Darco KB-G and Darco S-51) followed by 125 mL of either 15% acetic acid (AA) or 125 mL of 15% formic acid (AB). Bottles were mixed by shaking them vigorously.

### Calibration Curve Standards

A working solution containing acetaminophen standard (10 μg/mL) was prepared with LCMS-grade water. A series of volumetric dilutions were performed using the product matrix solution to obtain calibration standard concentrations from 0.25 to 2.0 μg/mL. The product matrix solution was obtained by filtering the supernatant from an unused drug disposal product bottle. A quality control (QC) sample was prepared at medium (1.2 μg/mL) concentration in the product matrix solution. Calibration curve solutions were made fresh and analyzed on a daily basis.

### Acetaminophen in Solution

65 g of acetaminophen powder was dissolved in 1 liter of 40% ethanol in 0.01 M phosphate buffer saline (PBS). 0.01 M PBS was dissolved in 600 mL of deionized (DI) water. 400 mL of ethanol was then added to the PBS in DI water.

### 8-Oz Bottle Loading Procedure

After mixing, 20 mL of 65 mg/mL acetaminophen in 40% ethanol in phosphate buffer saline was added to the slurry bottles. After the first 20-ml volume addition, subsequent additions of the 20-mL volumes were repeated every 2 days in the morning for a total of eight times. Table 7 shows the date when the 20-mL standard was added, the sample ID (acid type_extracted date), the total volume (mL) and the total amount of acetaminophen added in mg. For example, 1,300 mg of acetaminophen in solution was added to sample AA_0902 and extraction was performed 48 hours later. Next to the sample bottle, another 1,300 mg of acetaminophen was added, making a total of 2,600 mg of acetaminophen added to this bottle. So the next sample was extracted 48 hours after the additional acetaminophen was identified, and the sample was identified as AA_0904. This process was repeated every 48 hours, eight times.

TABLE 7

| | | Added Acetaminophen | |
|---|---|---|---|
| Date Added | Sample ID | (mL) | (mg) |
| 083115 | AA_0902 | 20 | 1300 |
| 090415 | AB_0906 | | |
| 090215 | AA_0904 | 40 | 2600 |
| 090615 | AB_0908 | | |
| 090415 | AA_0906 | 60 | 3900 |
| 090815 | AB_0910 | | |
| 090615 | AA_0908 | 80 | 5200 |
| 091015 | AB_0912 | | |
| 090815 | AA_0910 | 100 | 6500 |
| 091215 | AB_0914 | | |
| 091015 | AA_0912 | 120 | 7800 |
| 091415 | AB_0916 | | |
| 091215 | AA_0914 | 140 | 9100 |
| 091615 | AB_0918 | | |
| 091415 | AA_0916 | 160 | 10400 |
| 091815 | AB_0920 | | |

Volumes of 65 mg/mL acetaminophen in 40% methanol in 0.01 M PBS added every 48 hours for 8-oz acid A (AA) and 8-oz acid B (AB) bottles

### Extraction and Dilution Procedure

The 8-oz bottle was composed of acidified activated carbon and aquarium pebbles. This mixture has the appearance of a semi-liquid mixture, slurry. Removal of the supernatant (liquid lying above the activated carbon) was performed during extractions. The supernatant was then filtered using a 0.2 μm polytetrafluoroethylene (PTFE) membrane syringe filter to obtain a clear aliquot.

Aliquots from each extraction (e.g. AA_0902 to AA_0916) were kept in the freezer (−4° C.) until analysis time. Aliquots were removed from the freezer and dilutions were made using LC-MS water. These dilutions are shown in table 8.

TABLE 8
Samples' dilution fold.

| Sample ID | Dilution Fold |
|---|---|
| AA_0902 | 20 |
| AA_0904 | 100 |
| AA_0906 | 1000 |
| AA_0908 | 1000 |
| AA_0910 | 10000 |
| AA_0912 | 10000 |
| AA_0914 | 10000 |
| AA_0916 | 20000 |
| AB_0906 | 40 |
| AB_0908 | 200 |
| AB_0910 | 1000 |
| AB_0912 | 2000 |
| AB_0914 | 2000 |
| AB_0916 | 10000 |
| AB_0918 | 10000 |
| AB_0920 | 10000 |

### Method Description

Sample analysis was performed using the diluted aliquots. Each analysis was performed in triplicate. The method use for this analysis was as follows. Liquid chromatography was performed using a binary solvent delivery system (LC-20AD XR, Shimadzu) and autosampler (SIL-20AC XR, Shimadzu). Mobile phase A was composed of 10 mM ammonium formate (NH₄HCO₂, pH 6.7) in LCMS-grade water. Mobile phase B was composed of 10 mM NH₄HCO₂ in LCMS-grade methanol. Standard drugs were eluted with a gradient of 25-99% B over 5.5 min, followed by a 99% B hold for 1 min, and then system re-equilibration at 25% B for 3 min A flow rate of 400 μL/min was used. The column oven temperature was set to 50° C. Chromatographic separations were performed using a Raptor™ Biphenyl (Restek Corporation, Bellefonte, Pa.) (2.7 μm dp; 100×2.1 mm) column (biphenyl bonded phase on a superficially-porous particle). Sample injection volume was 1 μL. Averaged Elution time for acetaminophen was 1.109±0.005 min.

A working solution containing acetaminophen standard (10 μg/mL) was prepared with LCMS-grade water. A quick 5-point calibration curve was made using the product matrix solution to obtain calibration standard concentrations from 0.1 to 2.0 μg/mL. The product matrix solution was obtained by filtering the supernatant from an unused drug disposal product bottle. A quality control (QC) sample was prepared at medium (1.2 μg/mL) concentration in the product matrix solution. Calibration curve solutions were made fresh and analyzed on daily basis. The R² for this curve was 0.993.

### Detection Description

All measurements were performed on a Shimadzu LCMS-8040 (Shimadzu Scientific Instruments, Columbia, Md.) triple quadrupole HPLC-MS/MS instrument. The LCMS-8040 mass analyzer was operated using positive ionization electrospray ionization (ESI) and multiple reaction monitoring (MRM) modes. Acetaminophen MRM transitions were 151.95>110.05; 151.95>65.00 and 151.95>92.95. Source conditions were as follows: Interface voltage, 4.5 kV; nebulizer gas, nitrogen at 3 L/min; heat block temperature, 400° C.; desolvation line (DL) temperature, 250° C.; drying gas, nitrogen at 1.5 L/min; collision gas, argon at 230 kPa; and detector voltage, −1.86 kV. Acetaminophen MRM event times was from 0.4 to 1.9 min. Dwell time was 15 msec. The drug concentration for the unknowns was obtained by comparison of their respective areas to the equation of the standard curve, constructed by a weighed (1/C) quadratic model using the Lab Solution v.5.65 software.

### Results

Results are summarized in Table 9, which shows that the percentage adsorption decreased from 99.8% to 83.8% by adding approximately 10 times (10,400 mg) the initial amount (1,300 mg). As expected, as the product becomes saturated with acetaminophen, the adsorption decreased.

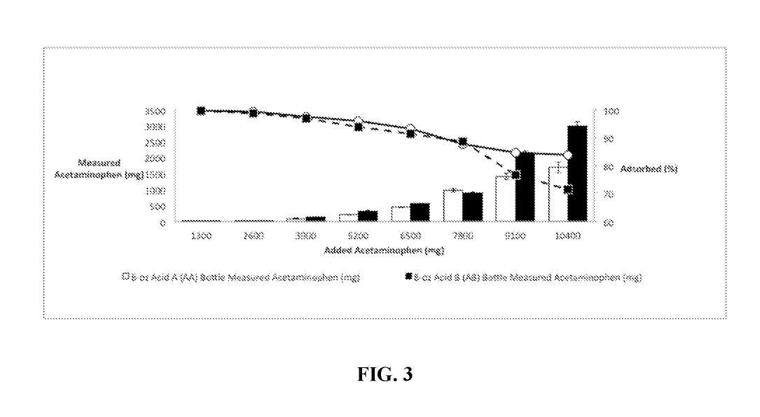

FIG. 3 illustrates the relation between the added acetaminophen in solution and the percentage adsorbed (%). [Added acetaminophen (mg) is on the x-axis, and measured acetaminophen (mg) is indicated on the left side y-axis, and the % adsorbed on the right side y-axis. The acid A bottle (AA) is represented by the unshaded bars, and the acid B bottle (AB) by the filled bars. The solid line with open circle markers designates % acetaminophen adsorbed using acid A; the dashed line with solid square markers designates % acetaminophen adsorbed using the acid B slurry.] As the amount added increased the adsorption percentage decreased for each 48-hour extraction. Also, this figure shows that acid A has a slightly higher adsorption percentage than acid B at amounts greater across the range of 1,300 mg to 10,400 mg of acetaminophen.

TABLE 9
Acetaminophen adsorbed for 8-oz acid (AA) and 8-oz acid B (AB) bottles.

| | | Acetaminophen | | | |
|---|---|---|---|---|---|
| Date | | Added | Measured Avg | Precision | Adsorbed |
| Added | Sample ID | (mg) | (mg) | (CV %) | (%) |
| 083115 | AA_0902 | 1300 | 2.6 | 4 | 99.8 |
| 090415 | AB_0906 | | 4.6 | 4 | 99.6 |
| 090215 | AA_0904 | 2600 | 20 | 5 | 99.2 |
| 090615 | AB_0908 | | 31 | 5 | 98.8 |
| 090415 | AA_0906 | 3900 | 94 | 7 | 97.6 |
| 090815 | AB_0910 | | 126 | 3 | 96.8 |
| 090615 | AA_0908 | 5200 | 204 | 2 | 96.1 |
| 091015 | AB_0912 | | 323 | 7 | 93.8 |
| 090815 | AA_0910 | 6500 | 446 | 2 | 93.1 |
| 091215 | AB_0914 | | 565 | 1 | 91.3 |
| 091015 | AA_0912 | 7800 | 970 | 5 | 87.6 |
| 091415 | AB_0916 | | 882 | 5 | 88.7 |
| 091215 | AA_0914 | 9100 | 1409 | 7 | 84.5 |
| 091615 | AB_0918 | | 2122 | 3 | 76.7 |
| 091415 | AA_0916 | 10400 | 1684 | 10 | 83.8 |
| 091815 | AB_0920 | | 2978 | 5 | 71.4 |

Modifications and variations will be apparent to those skilled in the art from the forgoing detailed description. All modifications and variations are intended to be encompassed by the following claims. All publications, patents, and patent applications cited herein are hereby incorporated by reference in their entirety.

What is claimed is:

1. A system for disposing of a drug comprising:
an aqueous acid;
activated carbon; and
a mechanical dissolution aid;
wherein the aqueous acid, activated carbon, and mechanical dissolution aid are provided in a slurry in a container.

2. The system of claim 1, wherein the aqueous acid comprises at least one of acetic acid and formic acid.

3. The system of claim 1, wherein the aqueous acid comprises an acid that is not acetic acid or formic acid.

4. The system of claim 1, wherein said drug is a solution based drug product.

5. The system of claim 4, wherein said drug is an oral solution, an elixir, an injectable drug, a cream, or a gel.

6. The system of claim 1, wherein said slurry comprises about 100 mL or less of aqueous acid per 50 g of activated carbon.

7. A method for disposing of a drug, comprising:
providing a system comprising a container containing a slurry of an aqueous acid, activated carbon, and a mechanical dissolution aid; and
adding the drug to the container,
whereby chemicals contained within the drug are irreversibly adsorbed onto the activated carbon, thus rendering said chemicals inactive and sequestered from further use.

8. The method according to claim 7, wherein said slurry comprises about 100 mL or less of aqueous acid per 50 g of activated carbon.

9. The method according to claim 7, wherein said drug is a solution based drug product.

10. The method according to claim 9, wherein said solution based drug comprises one or more active ingredients selected from the group consisting of acetaminophen, diazepam, hydrocodone, oxycodone, morphine and phenobarbital.

11. The method according to claim 9, wherein said solution based drug is an oral solution, an elixir, an injectable drug, a cream, or a gel.

12. The method according to claim 9, wherein said solution based drug comprises acetaminophen.

13. The method according to claim 12, wherein said solution based drug further comprises hydrocodone or oxycodone.

14. The method according to claim 7, wherein the aqueous acid comprises at least one of acetic acid and formic acid.

15. The method according to claim 7, wherein the aqueous acid comprises an acid that is not acetic acid or formic acid.

16. A kit for drug disposal comprising:
activated carbon;
a mechanical dissolution aid;
a container for drug disposal; and
instructions for activating said kit for disposal of a drug product.

17. The kit according to claim 16, wherein said instructions specify an amount of aqueous acid to add to the kit components in order to inactivate and sequester the ingredients contained within the drug product.

18. The kit according to claim 17, wherein the aqueous acid comprises at least one of acetic acid and formic acid.

19. The kit according to claim 17, wherein the aqueous acid comprises an acid that is not acetic acid or formic acid.

20. The kit for drug disposal according to claim 16, further comprising an aqueous acid.
